(19) United States
(12) Patent Application Publication
(10) Pub. No.: US 2025/0100125 A1
(43) Pub. Date: Mar. 27, 2025

(54) STACKABLE CONSTRUCTION SUPPORT

(71) Applicant: John Robert Carson, Sunman, IN (US)

(72) Inventor: John Robert Carson, Sunman, IN (US)

(21) Appl. No.: 18/471,480

(22) Filed: Sep. 21, 2023

(51) Int. Cl. B25H 1/00

(52) U.S. Cl. CPC B25H 1/0042

(57) ABSTRACT

A support comprising a hollow, pyramid-shaped body having a top portion and a base, the body including a plurality of tapered walls which meet at corners, each of the plurality of walls including a notch formed in the top thereof; a plurality of posts projecting upwardly from the top of the body; and a receiving area defined by the posts, wherein the support creates a stable foundation and evenly distributes the weight of a load that applied to or placed within the receiving area. The support is conveniently stackable with other supports of the same configuration.

### FIELD OF THE INVENTION

The present invention relates generally to providing working surfaces or structures useful in the woodworking industry, and in particular to stackable supports that are able to retain long support boards, such as lumber and the like.

### BACKGROUND OF THE INVENTION

In woodworking, a sawhorse or trestle is a support structure used to support a board or plank for sawing. Different versions of sawhorses are called different names depending on what they resemble, such as a mule or a pony, which come from the size and shape of the particular frame. A pair of sawhorses can be used to support a plank, forming a scaffold; or if the sawhorse is used as a rack for sawing logs and branches, it may be referred to as a sawbuck.

A sawhorse with a wide top is particularly useful to support a board for sawing or as a field workbench, and is more useful as a single, but also more difficult to store. A sawhorse can also be used as the base for a portable worktable by placing a sheet of plywood or even a door across two sawhorses. If the sawhorses are strong enough, the portable table can be used as a platform for tools like a table saw, although with caution if the top is not secured to the sawhorses. Sawhorses can also be useful in large projects, such as boatmaking.

While the prior art sawhorses described above can fulfill their respective particular objectives, they can be difficult to arrange when working on large, expanding projects such as building a large tabletop, or other large surfaces such as flooring. Traditional sawhorses can also make it difficult to keep a large project level, and can be time consuming to build, as well as awkward to store after use. Therefore, a need exists in the construction arts for a construction support that is adapted to not only reliably support construction materials for large, expanding projects, but is also stackable for more efficient transport and storage. It would also be advantageous to provide a construction support that has the strength and stability to withstand demanding and rigorous workloads.

### SUMMARY OF THE INVENTION

Briefly stated, the present invention provides significant improvements to known construction supports such as sawhorses, and can provide better weight distribution and a more stable working surface while being easily transported and stored when not in use.

A first aspect of the invention provides a construction support comprising a hollow, pyramid-shaped body having a top portion and a base, the body including a plurality of tapered walls which meet at corners, each of the plurality of walls including a notch formed in the top thereof; a plurality of posts projecting upwardly from the top of the body; and a receiving area defined by the posts, wherein the support creates a stable foundation and evenly distributes the weight of a load that is applied to or placed within the receiving area.

A second aspect of the invention provides a method of using a plurality of construction supports, each of the plurality of construction supports comprising: (i) a hollow, pyramid-shaped body having a top portion and a base, the body including a plurality of tapered walls which meet at corners, each of the plurality of walls including a notch formed in the top thereof; (ii) a plurality of posts projecting upwardly from the top of the body; and (iii) a receiving area defined by the posts, the method comprising the steps of: (a) inserting a plurality of wooden planks in intersecting relationships to one another within the receiving areas of the plurality of construction supports; and (b) arranging the plurality of the construction supports to create a stable foundation and evenly distribute the weight of a load applied by the plurality of wooden planks within the receiving areas of the plurality of construction supports.

These and other aspects of the present invention will be more fully appreciated with respect to the following drawings and detailed description.

### BRIEF DESCRIPTION OF THE DRAWINGS

FIG. 1 is a perspective view of a preferred embodiment of a construction support in accordance with the present invention;

FIG. 2 is a side view of the support of FIG. 1;

FIG. 3 is a top view of the support of FIG. 1;

FIG. 4 is a perspective view of a large, expanding project utilizing a preferred embodiment of a support in accordance with the present invention;

FIG. 5 is a perspective view of a plurality of stacked construction supports.

### DETAILED DESCRIPTION OF THE INVENTION

The construction support described herein is capable of being used together with others of its kind to create large, stable, modular working surfaces or structures. Each support includes a wide base which allows it to stand securely on the ground, and is typically made of molded plastic or other durable, non-corrosive materials that are easy to manufacture and use. When used together a plurality of construction supports are able to retain long construction sheets such as lumber, and can provide more versatility in leveling and setting the height of the working surface in a given application.

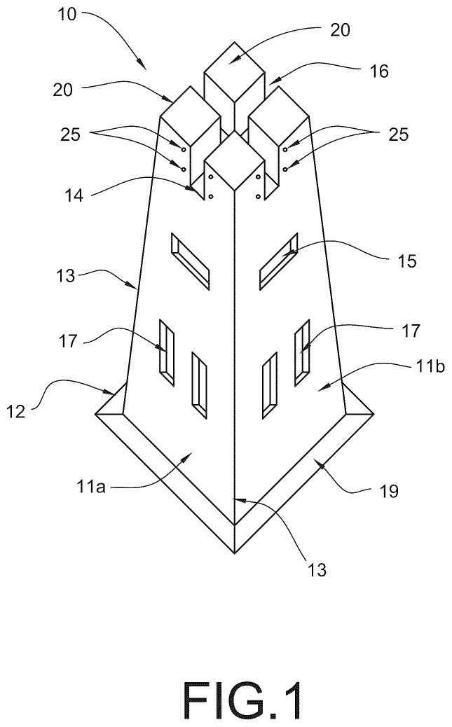

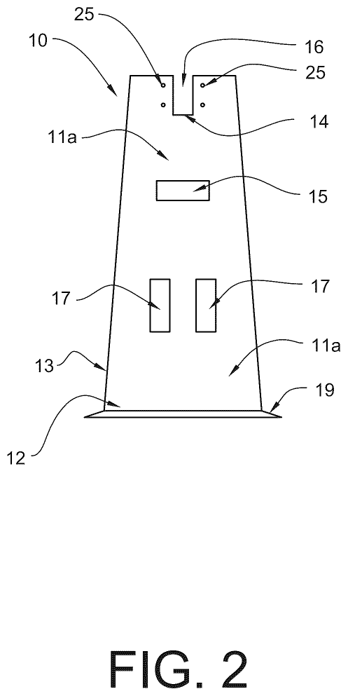

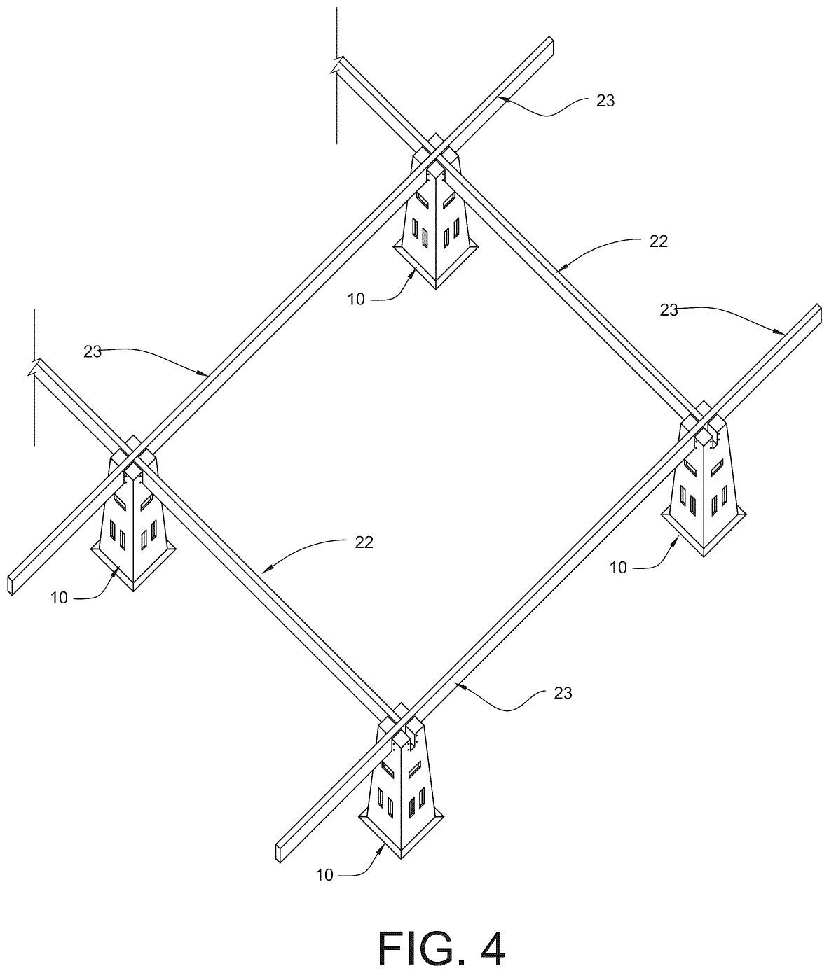

Referring now to FIGS. 1-3, a preferred embodiment of the inventive construction support is illustrated having a hollow, pyramid-shaped body 10 bounded by four walls 11a, 11b, 11c, and 11d which meet at corners 13. The top portions of each wall 11a-11d each include a cut-out or notch 16, as best seen in FIG. 1. When assembled together as shown, the four walls 11a-11d and their notches 16 create a receiving area 14 at the top of the body 10, defined by adjacent posts 20 which project upwardly around the receiving area 14. The base 12 of the support 10 creates a stable foundation and evenly distributes the weight of any load that is applied to or placed within the receiving area 14. For example, the receiving area 14 can be specifically shaped for fitting lumber or large wood planks, which are dropped into the receiving area of the support 10 (see FIG. 4). As shown in FIG. 1, the posts 20 can be topped off or covered, but they can also be merely made of two adjoining walls (i.e., of walls 11a-11d) as they meet at one of the corners 13. FIGS. 1 and 2 also illustrate screw holes 25 placed in the posts 20 at the sides of the notches 16, which will be described in more detail below, and apertures 15, 17 which serve as “hand holes” or handles for carrying the support 10. These hand holes include both single horizontal apertures 15 and pairs of vertical apertures 17 for grabbing or picking up the support by hand; however, it can be appreciated that a variety of shapes, sizes, and numbers of apertures can be used. In addition, alternative embodiments of the support may include a rounded cross-section, as well as elliptical, or even a hybrid shape, such as a square/pyramid base with a rounded foot member.

The top portions of each wall 11a-11d each include a cut-out or notch 16, as best seen in FIG. 1. When assembled together as shown, the four walls 11a-11d and their notches 16 create a receiving area 14 at the top of the body 10, defined by adjacent posts 20 which project upwardly around the receiving area 14. The base 12 of the support 10 creates a stable foundation and evenly distributes the weight of any load that is applied to or placed within the receiving area 14. Each of the walls 11a-11d gradually widens from the top posts 20 down to the base 12; specifically, the width of each wall 11a-11d can range between about six inches and nine inches at the top (preferably about eight inches wide), and can increase to between about ten inches and fourteen inches at the base 12 (preferably about twelve inches wide). In addition, each notch 16, as well as the receiving area 14 created by the notches when the walls 11a-11d are joined at the corners 13, can be about 1½ inches wide and about three inches deep, for fitting a wooden plank ranging in size from a “2 by 4” to a “2 by 12”. The lower base 12 can optionally include a foot member 19 which extends around the perimeter of the base 12 to help keep the support 10 level. For example, the foot member 19 can be a singular flattened, disc-like platform that forms a solid band of material extending horizontally outwardly from the base about one-half inch and two inches, increasing the final width of the base 12 of the support to between about eleven inches and fifteen inches.

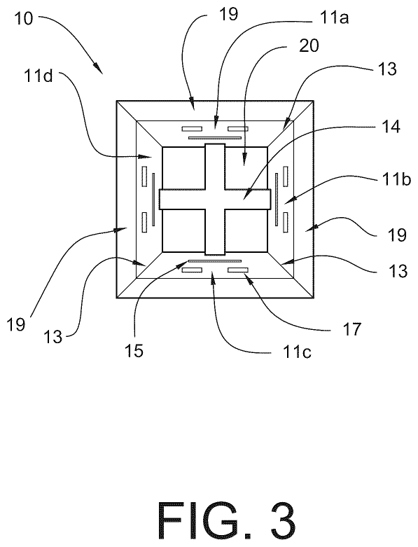

As best seen in the top view of the support shown in FIG. 3, the receiving area 14 is the geographical center of the support 10, and the corners 13 proceed in a straight line from the posts 20 to the base 12. The foot member 19 can help to form a larger base, adapted to support the weight of an anticipated large load placed into the receiving area 14, such as wooden planks 22, 23 (see FIG. 4). As shown in FIG. 4, wooden planks 22, 23 can be inserted into and retained in intersecting, orthogonal, or otherwise substantially perpendicular relationships to one another within the receiving areas 14 of the supports 10. The planks 22, 23 can then be fixed or retained at these points of intersection by reversibly screwing or nailing the planks 22, 23 to the supports 10, for example, via screw holes 25 placed in the posts 20 at the sides of the notches 16 (see FIGS. 1 and 2). It is envisioned that a plurality of supports 10 can be used on a single, large project by arranging them in a manner that creates a stable foundation and evenly distributes the weight of a load applied by the wooden planks within the receiving areas of the supports. For example, as illustrated in FIG. 4, a project can include a set of four supports 10 to support wooden planks 22, 23, in order to begin building a tabletop, and then additional supports can be added to the project as the size of the tabletop grows. The supports are also envisioned for use in creating structures such as police barricades, temporary work surfaces, flooring, or above ground stages for use during outdoor concerts, flea markets, yard sales, etc.

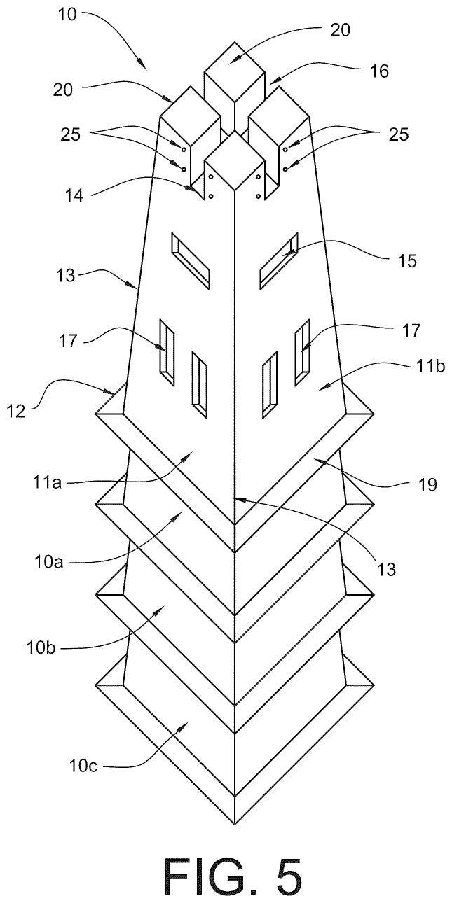

In one embodiment, shown in FIG. 5, a plurality of the inventive construction supports 10, 10a, 10b, and 10c each of which are identical and which include inner and outer surfaces which are substantially complementary to each other, to allow the plurality of supports to be stacked together, one inside the other, for more efficient storage and transport. The combination of the tapered, generally funnel-like shape of bodies, along with complementary inner and outer surfaces can allow, for example, support 10c to be inserted within the lower opening of support 10b, such that outer surface of the support 10c slidably engages the inner surface of the support 10b. In this manner, the plurality of supports 10, 10a, 10b, and 10c can be stacked together, one inside the other, for packaging, storage and transport. The distance that one support is able to be introduced inside another is dependent upon the degree of slope assumed by wall surfaces 11a-11d as they progress from bottom to top. Preferably, the slope is sufficient to allow a substantial portion of each support to fit within another support, such that a great number of supports can be stacked in a minimal amount of space without the stack becoming too tall or burdensome. In this way, the support can provide a more efficient method for storage and transport when not in use.

The embodiments of the construction support described herein are preferably a single mold, unitary, one-piece construction having a substantially similar density throughout, weighing between about 2 pounds and 5 pounds. Typically each single-piece construction support is made of a unitary polymeric material that is suitably high strength and weather resistant, such as a one-piece injection molded plastic or resin material like polypropylene, polyurethane, polyethylene, rubber, vinyl, neoprene, etc.; however, it can also be constructed of wood or a non-corrosive metal. As a non-limiting example, the support can be made of a relatively hard plastic material having a 55 Shore-D value or greater. A person having skill in the art will recognize that other materials exhibiting similar characteristics of being lightweight, strong and resilient can be used. In general the material strength of the support should be able to resist the downward, compressive force of at least about 500 pounds of weight placed into the receiving area of the support. The future development of new materials can improve the capabilities of the support; thus, while certain material preferences have been noted, adjustments may be made to the type, the hardness or the softness of the support material, to improve support strength, reduce material volume, or improve durability.

While the present invention is illustrated herein in considerable detail, such detail is not intended to restrict or in any way limit the scope of the appended claims. Additional advantages and modifications will be readily apparent to those skilled in the art without departing from the concept or scope of the invention.

What is claimed is:

1. A construction support, comprising:
a) a hollow, pyramid-shaped body having a top portion and a base, the body including a plurality of tapered walls which meet at corners, each of the plurality of walls including a notch formed in the top thereof;
b) a plurality of posts projecting upwardly from the top of the body; and
c) a receiving area defined by the posts, wherein the support creates a stable foundation and evenly distributes the weight of a load that applied to or placed within the receiving area.

2. The support of claim 1, wherein the body has an inner surface and an outer surface, and wherein the inner and outer surfaces are substantially complementary to each other to allow a plurality of supports to be stacked within one another for storage and transport.

3. The support of claim 1, wherein the receiving area is adapted to secure wooden planks in intersecting relationships to each other.

4. The support of claim 1, wherein each of the walls ranges between about six inches wide and nine inches wide at the top, and preferably about eight inches wide at the top, and wherein each of the walls ranges between about ten inches wide and fourteen inches wide at the base, and preferably about twelve inches wide at the base.

5. The support of claim 1, wherein the lower base includes a foot member which extends around the perimeter of the base to help keep the support level.

6. The support of claim 1, wherein the support is constructed of a single piece of resilient polymeric material.

7. The support of claim 1, wherein each of the plurality of posts are formed by two adjoining walls of the plurality of walls as they meet at one of the corners of the support.

8. The support of claim 1, wherein each of the plurality of construction supports further comprises at least one screw hole placed next to each of the plurality of notches.

9. The support of claim 1, wherein each of the plurality of walls further include at least one hand hole for carrying the support.

10. The support of claim 9, wherein each of the plurality of walls includes both single horizontal apertures and pairs of vertical apertures for grabbing or picking up the support by hand.

11. A method of using a plurality of construction supports, each of the plurality of construction supports comprising: (i) a hollow, pyramid-shaped body having a top portion and a base, the body including a plurality of tapered walls which meet at corners, each of the plurality of walls including a notch formed in the top thereof; (ii) a plurality of posts projecting upwardly from the top of the body; and (iii) a receiving area defined by the posts,
the method comprising the steps of:
a) inserting a plurality of wooden planks in intersecting relationships to one another within the receiving areas of the plurality of supports; and
b) arranging the plurality of the construction supports to create a stable foundation and evenly distribute the weight of a load applied by the plurality of wooden planks within the receiving areas of the plurality of construction supports.

12. The method of claim 11, wherein each of the plurality of construction supports further comprises at least one screw hole placed next to each of the plurality of notches, and wherein each of the plurality of wooden planks are retained at points of intersection within the receiving areas by reversibly screwing or nailing each of the plurality of wooden planks to the supports through the screw holes.
